(19) United States
(12) Patent Application Publication
(10) Pub. No.: US 2009/0213230 A1
(43) Pub. Date: Aug. 27, 2009

(54) IMAGE CAPTURE METHOD AND SYSTEM

(75) Inventors: Kun-Chi Liao, Taichung (TW); Chi-Shu Huang, Taichung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASIA OPTICAL CO., INC., Taichung (TW)

(21) Appl. No.: 12/345,859

(22) Filed: Dec. 30, 2008

(30) Foreign Application Priority Data
Feb. 22, 2008 (TW) 97106250

(51) Int. Cl. H04N 5/00

(52) U.S. Cl. 348/207.99; 348/E05.001

(57) ABSTRACT

An image capture method for capturing an image with a single lens is provided. The method includes: (a) sequentially moving an image capture unit to predetermined positions; (b) sequentially capturing a plurality of frames of images by the image capture unit at the predetermined positions, wherein at least one image distance difference exists among the images; and (c) generating at least one image file by a processing unit according to the images.

### CROSS REFERENCE TO RELATED APPLICATIONS

This Application claims priority of Taiwan Patent Application No. 097106250, filed on Feb. 22, 2008, the entirety of which is incorporated by reference herein.

### BACKGROUND OF THE INVENTION

1. Field of the Invention

The present invention relates to an image capture method and system, and more particularly to an image processing method and a system capable of processing a plurality of images.

2. Description of the Related Art

Driven by advanced developments in image capture technology, users are demanding more vivid colors and perceptual gradation of color of digital still images and motion images. Therefore, one challenge for designers in the field is to develop an image capture and processing method for a digital image capture system that provides vivid and lively three-dimensional image files.

For three-dimensional objects, the viewing angle of a persons' left eye is different from the persons' right eye due to different specific distances. Thus, when one three-dimensional object light beam image sensed by the left eye and right eye is received, an image distance difference is generated. When the brain combines the images sensed by the left eye and right eye, the brain determines whether the combined image is a three-dimensional image or a two-dimensional image according to the image distance difference.

Therefore, in conventional technology, to present three-dimensional images, two image capture devices are set at a predetermined distance to simulate the left eye and right eye of humans and then the image capture devices simultaneously captures a pair of images to determine whether an image distance difference exists among each pair of images.

When a user views image data, the pair of images, i.e. two frames of images, is simultaneously presented on one plane. Thus, a user must wear a specific pair of glasses to adjust the image data when entering the left eye and the right eye. The brain then determines whether an image distance difference exists among the received pair of images. If yes, the brain processes the image data more like a vivid three-dimensional image versus a two-dimensional image.

Therefore, producing more vivid and brighter colors for the user.

### BRIEF SUMMARY OF THE INVENTION

According to the aforementioned description, an embodiment of the invention provides a two image capture method and an image capture system, using a single image-capturing lens.

An embodiment of the invention provides an image capture method comprising: (a) sequentially capturing a plurality of frames of images by an image capture unit, wherein an image distance difference exists among each pair of images; and (b) processing the images by a processing unit to provide at least one image file.

Another embodiment of the invention provides an image capture method comprising: (a) sequentially moving an image capture unit to predetermined positions to capture a plurality of the frames of images; and (b) generating at least one image file by a processing unit according to the images.

Another embodiment of the invention provides an image capture system. The system comprises an image capture unit and a processing unit. The image capture unit sequentially captures a plurality of the frames of images. The processing unit generates at least one image file according to the images.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of an embodiment of an image capture system according to the invention.

FIG. 2 is a flowchart of an embodiment of an image file generation method according to the invention.

FIG. 3 is a flowchart of another embodiment of an image file generation method according to the invention.

FIG. 4 is a flowchart of an embodiment of a motion image file generation method according to the invention.

FIG. 5 is a flowchart of another embodiment of a motion image file generation method according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

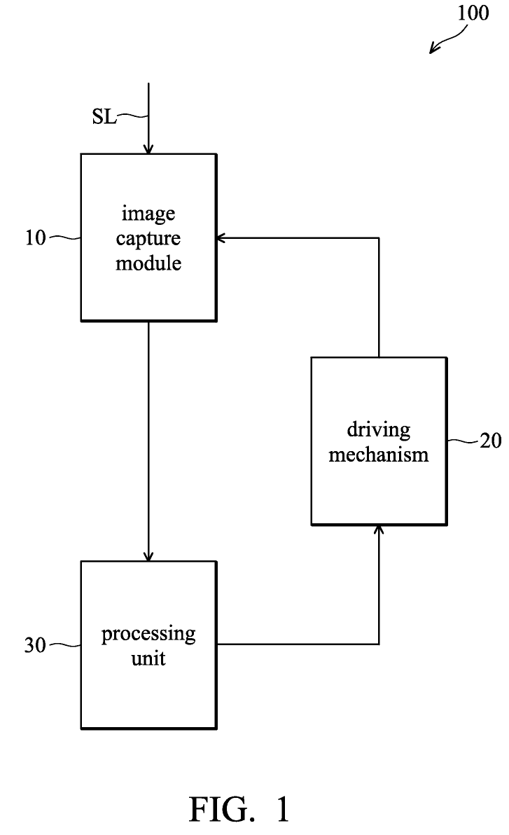

FIG. 1 is a schematic diagram of an embodiment of an image capture system according to the invention. As shown in FIG. 1, the image capture system 100 comprises an image capture module 10, a driving mechanism 20 and a processing unit 30, wherein the image capture module 10 can execute different image capture modes, such as a still image capture mode and a motion image capture mode, but the invention is not limited thereto.

The image capture module 10 comprises an image capture unit and an image-capturing lens for capturing images. The image capture module 10 uses a single image-capturing lens to capture images. The image capture unit may be a charge-coupled device (CCD) or a complementary metal-oxide-semiconductor (CMOS) device.

The driving mechanism 20 comprises a socket and a driving part, wherein the image capture unit is disposed on the socket and the driving part is connected to the socket to move the image capture unit to predetermined positions to capture corresponding images.

The processing unit 30 processes the image captured by the image capture module to generate a still image file or a motion image file with high perceptual gradation of color.

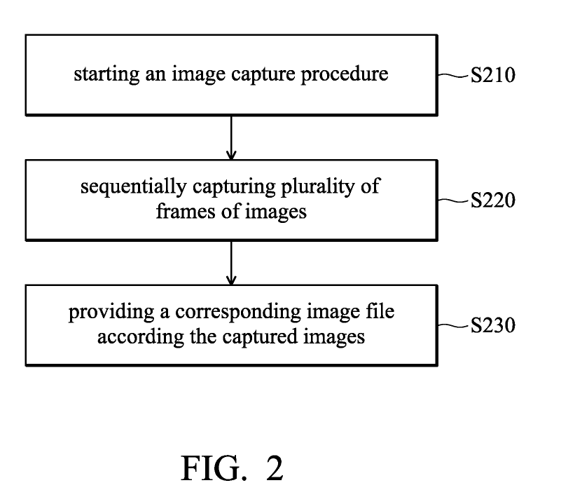

FIG. 2 is a flowchart of an embodiment of an image file generation method according to the invention. In step S210, the image capture system 100 starts an image capture procedure. In step S220, the image-capturing lens of the image capture system 100 receives the light signal SL and the image capture unit senses the light signal SL in a specific order to acquire a plurality of frames of corresponding images, wherein the images comprises at least two images with an image distance difference.

In step S230, the processing unit 30 provides a corresponding image file according to the pixel parameters or by merging the captured images. In one embodiment, the processing unit 30 merges the overlapped areas of the images and removes the non-overlapped areas of the images to generate at least one initial image frame. Then, the processing unit 30 processes the initial image according to the pixel parameters thereof to generate the still image file, wherein the image parameters is a pixel data, for example a value of pixel in the image or a value of pixel generated by the image capture module 10. In another embodiment, the processing unit 30 compares the corresponding images and estimates the pixel parameters of the still image file according to the pixel parameters of the corresponding images.

In one embodiment of the present application, the processing may be accomplished by a microprocessor, a microcontroller or a control unit, but the invention is not limited thereto. Furthermore, the image capture system 100 can be applied in a digital camera, a digital camcorder, a cell phone, a personal digital assistance (PDA) or other electronic devices capable of photographer or film-shooting, but the invention is not limited thereto.

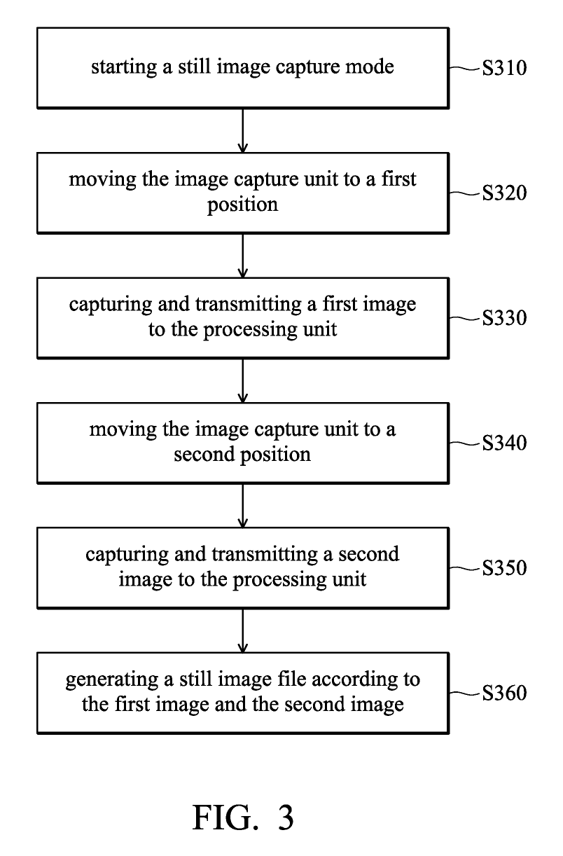

FIG. 3 is a flowchart of another embodiment of an image file generation method according to the invention. The flowchart of FIG. 3 is the typical implementation steps of the flowchart of FIG. 2.

In step S310, the image capture system 100 enters a still image capture mode. In step S320, the driving part of the driving mechanism 20 moves the image capture unit to a first position. In step S330, the image-capturing lens of the image capture module 10 receives the light signal SL, and the image capture unit then senses the light signal SL to output a first image, and the first image is then transmitted to the processing unit 30. In step S340, the driving part of the driving mechanism 20 moves the image capture unit to a second position. In step S330, the image-capturing lens of the image capture module 10 receives the light signal SL, and the image capture unit then senses the light signal SL to output a second image, and the second image is then transmitted to the processing unit 30. The first image and the second image are defined as a pair of corresponding images and an image distance difference exists between the first image and the second image.

In step S360, the processing unit 30 merges the first image and the second image to provide a still image file. In another embodiment, the still image file is generated based on the pixel parameters of the acquired images. In one embodiment, the processing unit 30 merges the overlapped areas of the images and removes the non-overlapped areas of the images to generate at least one initial image frame. Then, the processing unit 30 processes the initial image according to the pixel parameters thereof to generate the still image file. In another embodiment, the processing unit 30 compares the corresponding images and estimates the pixel parameters of the still image file according to the pixel parameters of the corresponding images.

In the described methods, in order to acquire a pair of images with an image distance difference, the image capture unit captures the first image and the second image at the first position and the second position and then the processing unit 30 processes the first image and the second image to generate a still image file. It is noted that those skilled in the art can use more than two images with image distance differences to generate the still image file via the processing unit 30.

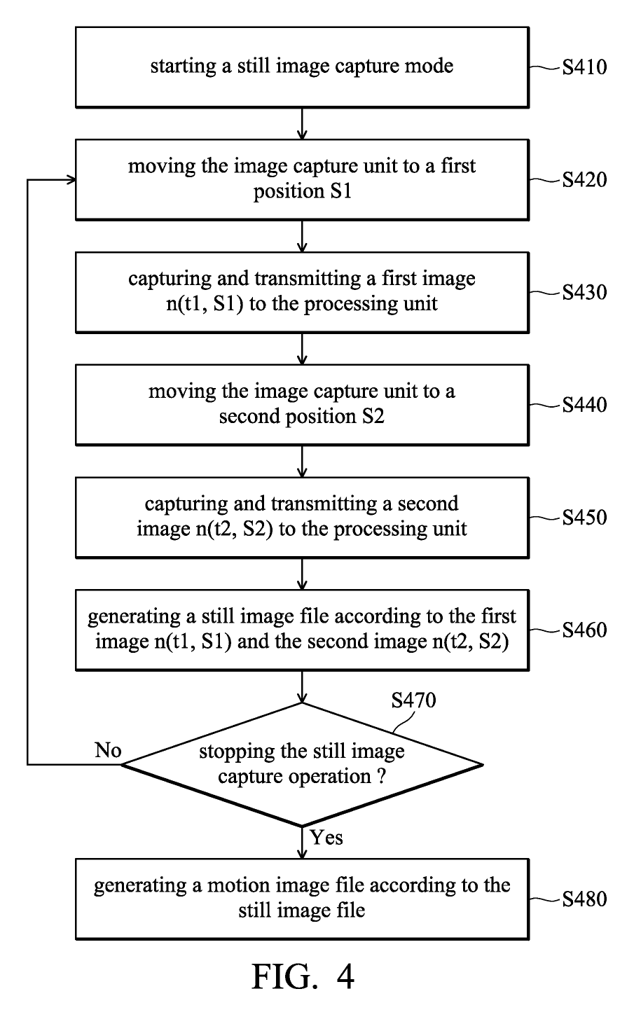

FIG. 4 is a flowchart of an embodiment of a motion image file generation method according to the invention. In step S410, the driving part of the driving mechanism 20 moves the image capture unit to a first position S1 for a first period of time, t1. In step S430, the image-capturing lens of the image capture module 10 receives the light signal SL, and the image capture unit then senses the light signal SL to output a first image n(t1, S1), and the first image n(t1, S1) is then transmitted to the processing unit 30. In step S440, the driving part of the driving mechanism 20 moves the image capture unit to a second position for a second period of time, t2. In step S450, the image-capturing lens of the image capture module 10 receives the light signal SL, and the image capture unit then senses the light signal SL to output a second image n(t1, S2), and the second image n(t2, S2) is then transmitted to the processing unit 30. In step S460, the processing unit 30 generates and stores a still image file Ft1 in a temporal storage device according to the first image n(t1, S1) and the second image n(t2, S2).

In step S470, the image capture system 100 determines whether a stop instruction to stop the film-shooting is received. If not, the image capture system 100 repeats the steps S420 to S470 to acquire a first image n(ti, S1) and second image (ti, S2) at the i^{th} period of time, ti. The processing unit 30 generates and stores a still image file Fti in the temporal storage device according to the first image n(ti, S1) and the second image n(ti, S2), where I is a positive integer number.

If the stop instruction has been received in the step S470, the processing unit 30 combines the image files Ft1 to Fti to generate the motion image file (step S480).

The first image n(ti,S1) and the second image n(ti,S2) are defined as a pair of corresponding images and an image distance difference exists between the first image and the second image. It is noted that those skilled in the art can use more than two images with image distance differences to generate the still image file via the processing unit 30.

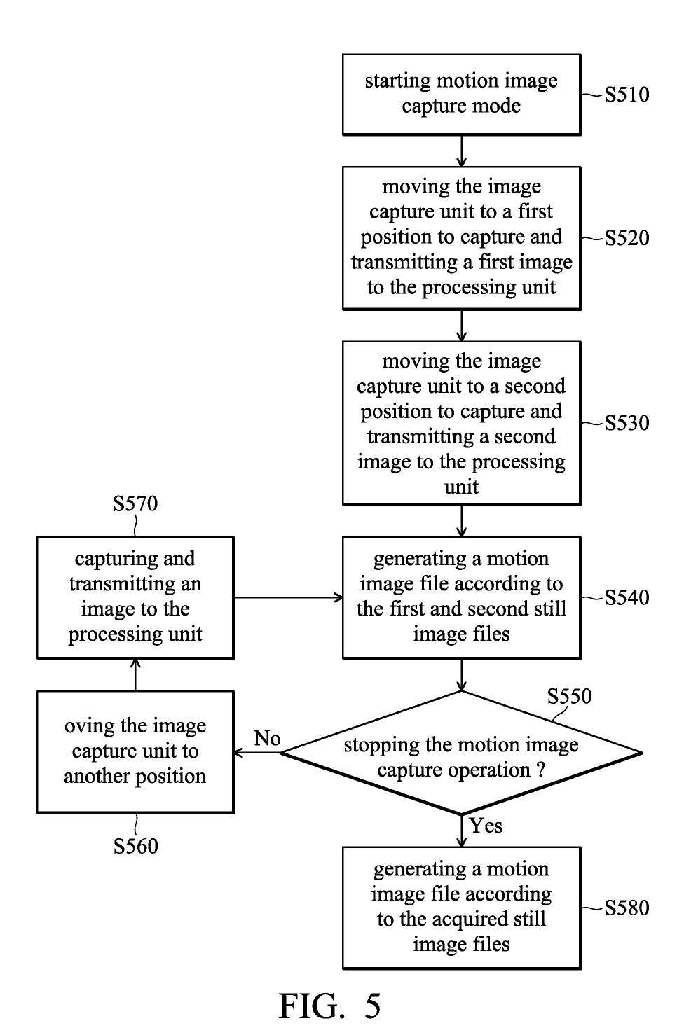

FIG. 5 is a flowchart of another embodiment of a motion image file generation method according to the invention. In step S510, the image capture system 100 enters a motion image capture mode. In step S520, the driving part of the driving mechanism 20 moves the image capture unit to a first position to capture and transmit the image n1 to the processing unit 30. In step S530, the driving part of the driving mechanism 20 moves the image capture unit to a second position to capture and transmit the image n2 to the processing unit 30. In step S540, the processing unit 30 combines the last two captured images to generate and store a still image file in a temporal storage device. In this embodiment, the last two images are the images n1 and n2, thus, the processing unit 30 combines the images n1 and n2 to generate and stores a still image file in a temporal storage device.

In step S550, the image capture system 100 determines whether a stop instruction for stopping the film-shooting has been received. If not, the step S560 is executed. In step S560, the image capture unit is moved to a third position, wherein the third position may be the first position or a specific position pre-set by the image capture system 100. In step S570, the image ni is acquired and transmitted to the processing unit 30 and the step S540 is executed again. In step S540, the processing unit 30 combines the last two captured images, n(i−1) and ni, to generate and store a still image file in a temporal storage device, wherein i is a positive integer number and larger than two.

The steps S540 to S570 are executed repeatedly until a stop instruction to stop the film-shooting is received by the image capture system 100 in step S550. When the image capture system 100 receives the stop instruction, the processing unit 30 combines the still image files to generate a motion image file (step S580).

In other words, if the image capture system 100 does not receive the stop instruction, the image capture unit captures images with different image distance difference at different positions, and the processing unit 30 generates a still image file according to the last two captured images. In other words, the first still image file is generated according to the images n1 and n2, the second still image file is generated according to the images n2 and n3, and so on. It is noted that those skilled in the art can use three images with different image distance differences to generate the still image file. Furthermore, the image capture unit can captures images with image distance difference between each two images sequentially or randomly at two or more than two different positions.

The embodiment of the present invention discloses a still image generation method according to the image distance difference at the captured images. The still image is generated by blending the images or according to the pixel parameters of the captured images. As to the motion image file, the motion image file is generated by combining a plurality of still image files which are generated according to the image distance difference between the captured images.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image capture method, comprising:
(a) sequentially capturing a plurality of frames of images by an image capture unit, wherein an image distance difference exists among each pair of images; and
(b) processing the images by a processing unit to provide at least one image file.

2. The method as claimed in claim 1, wherein the step (b) further comprises:
(b1) merging the images to generate at least one still image frame; and
(b2) combining the still images to generate a motion image file.

3. The method as claimed in claim 2, further comprising:
(b3) determining whether a stopping instruction has been received, and repeating step (a) and correspondingly providing the still images if the stopping instruction has not been received.

4. The method as claimed in claim 3, wherein if the stopping instruction has been received, executing the step (b2) to combine the still images to generate the motion image file.

5. The method as claimed in claim 1, further comprising:
sequentially moving the image capture unit to predetermined positions and capturing the frames of images by the image capture unit at the predetermined positions.

6. The method as claimed in claim 5, further comprising:
merging the images by the processing unit to generate at least one still image frame.

7. The method as claimed in claim 5, further comprising:
estimating pixel parameters of the still image, via the processing unit, by comparing the pixel parameters of the images.

8. The method as claimed in claim 6, wherein the image capture unit captures a first image at a first position and a second image at a second position, and the still image is generated based on the first image and the second image.

9. The method as claimed in claim 8, further comprising:
combining the still images via the processing unit to generate a motion image file.

10. An image capture method, comprising:
(a) sequentially moving an image capture unit to predetermined positions to capture a plurality of the frames of images; and
(b) generating at least one image file by a processing unit according to the images.

11. The method as claimed in claim 10, wherein the image capture unit captures a first image at a first position and a second image at a second position.

12. The method as claimed in claim 11, wherein the processing unit merges the first image and the second image to generate the image file.

13. The method as claimed in claim 11, wherein the processing unit generates a still image file according to the pixel parameters of the first image and second image.

14. The method as claimed in claim 10, wherein the step (b) further comprises:
(b1) determining whether a stopping instruction has been received, and repeating step (a) and correspondingly providing the still images if the stopping instruction has not been received; and
(b2) if the stopping instruction has been received, combining the still images to generate a motion image file.

15. An image capture system, comprising:
an image capture unit to sequentially capture a plurality of the frames of images; and
a processing unit to generate at least one image file according to the images.

16. The system as claimed in claim 15, wherein the image capture unit captures a first image at a first position and a second image at a second position, and the processing unit generates a still image file according to the first image and the second image.

17. The system as claimed in claim 16, wherein the processing unit merges the first image and the second image to generate the still image file or generates the still image file according to the pixel parameters of the first image and second image.

18. The system as claimed in claim 15, wherein the image capture unit captures the images at a plurality of specific positions and the processing unit generates a plurality of frames of still image files according to the captured images.

19. The system as claimed in claim 18, wherein the processing unit provides the still image files according to the image distance difference between the captured images or the pixel parameters of the captured images.

20. The system as claimed in claim 18, wherein the processing unit further provides a motion image file by combining the still image files.
